(19) United States
(12) Patent Application Publication
(10) Pub. No.: US 2005/0252126 A1
(43) Pub. Date: Nov. 17, 2005

(54) Door of glass fiber-reinforced plastic

(76) Inventor: Shih-Ying Chan, Shihcheng Township (TW)

Correspondence Address: KUO-HSIUNG CHIU, 13F., NO.23, JIUN-HO STREET, PEITUN DISTRICT, TAICHUNG, 406, TW

(21) Appl. No.: 10/845,319

(22) Filed: May 14, 2004

(51) Int. Cl. E06B 3/00

(52) U.S. Cl. 52/309.9

(57) ABSTRACT

A door of glass fiber-reinforced plastic having two door panels and four sealing strips. Each of door panels has a pair of projecting stripes at the top and bottom thereof. Each of the four peripheral sides of the door panels are enclosed by sealing strips. Each of the sealing strips has an I-shaped section, and includes an attachment portion. Two insertion grooves are formed between the sealing strip and the attachment portion to permit the insertion of both door panels with their projecting stripes thereinto. A plurality of stiffening ribs is interposed between both door panels. Accordingly, drawbacks of the prior art can be eliminated by the door of the invention that is completely formed in a rectangular shape. The door panels are made of fiber-reinforced plastic to create a visual effect of simulation of wood grains. The sealing rims of the prior art are no more existing in the invention so that the whole appearance won't be affected.

### BACKGROUND OF THE INVENTION

1. Fields of the Invention

The invention relates to a door, and more particularly, to a door that is made of glass fiber-reinforced plastic (GRP) and simulates doors with wood grains. Meanwhile, a plurality of stiffening ribs and foaming materials is provided in the interior between both door panels.

2. Description of the Related Art

Previously, wood is an important material for doors, windows, and furniture as well as for interior decoration. Due to the environmental awareness, the wood material has been gradually replaced by aluminum, metal, plastic (PVC or ABS) material. At present, GRP simulates a wood grain to be material for doors, windows, and furniture.

GRP is a composite material of glass filament and glass fabric both of which are embedded in epoxy resin for increasing strength and stiffness thereof. House's and furniture's doors made of GRP have been criticized for a long time. The invention is designed to eliminate following drawbacks.

Referring to FIG. 3, a conventional door 10 is illustrated. Two door panels 11 are made of GRP. A plurality of stiffening ribs 12 and foaming materials 13 are interposed between the two door panels 11. The filling density of the foaming materials 13 plays an important part in the sound insulation. Thereafter, the peripheral sides of the door 10 are enclosed by sealing strips 14.

The door panels 11 made of GRP can simulate a wood grain. However, the door 10 consisting of these door panels 11 and sealing strips 14 of aluminum, plastic, tough, and rigid materials demonstrates a visually distinct color difference.

Each sealing strip 14, as shown in FIG. 4, includes two elongated grooves 15 in parallel at one side thereof to allow the insertion of the respective door panels 11 into the grooves 15. Each sealing strip 14 includes two sealing rims 16 against the respective door panels 11. Due to expanding action with heat and shrinking action with cold on the sealing rims 16, the sealing rims 16 easily become warped. Thereafter, the warped portion doesn't restore to its original shape owing to the properties of tough or stiff materials. As a result, this warped portion may cause serious injuries to any persons or objects around it.

Moreover, the mounting of the sealing rims 16 on the door panels 11 will create differences in height and thickness so that, in addition to affecting the whole appearance, the door 10 easily shakes when the door 10 is violently closed.

Another door of glass fiber-reinforced plastic, as illustrated in FIG. 5, also includes two door panels 11 made of GRP. A plurality of stiffening ribs 12 and foaming materials 13 are interposed between the two door panels 11. Thereafter, the peripheral sides of the door 10 are enclosed by sealing strips 14. The sealing strips 14 according to the embodiment in FIG. 5 has a T-shaped section. Both elongated edges 17 of each sealing strips 14 lie on the respective peripheral surfaces of the door panels 11. Meanwhile, a gap 18 is created between the respective elongated edge 17 and the respective door panel 11 when the four peripheral sides of the door panels 11 made of GRP don't have smooth cut surface. This kind of door of glass fiber-reinforced plastic can achieve the visual uniformity of the whole appearance. However, the pressure-resistance thereof is insufficient and, therefore, the door is subject to break. As a result, this kind of door has been gradually weeded out from the market.

### SUMMARY OF THE INVENTION

It is a primary object of the invention is to provide a door of glass fiber-reinforced plastic whose rim portions won't be warped so that human bodies and objects around it can be prevented from injuries and damages.

It is another object of the invention is to provide a door of glass fiber-reinforced plastic that simulates wood grains and has a whole uniformity on the surface thereof.

### BRIEF DESCRIPTION OF THE DRAWINGS

The accomplishment of this and other objects of the invention will become apparent from the following description and its accompanying drawings of which:

FIG. 1 is a perspective view of a door of the invention in section;

FIG. 2 is a side view, partly in section, of the door of FIG. 1;

FIG. 3 is a perspective view of a conventional door in section;

FIG. 4 is a side view, partly in section, of the door of FIG. 3; and

FIG. 5 is a perspective view of another conventional door in section.

### DETAILED DESCRIPTION OF THE PREFERRED EMBODIMENT

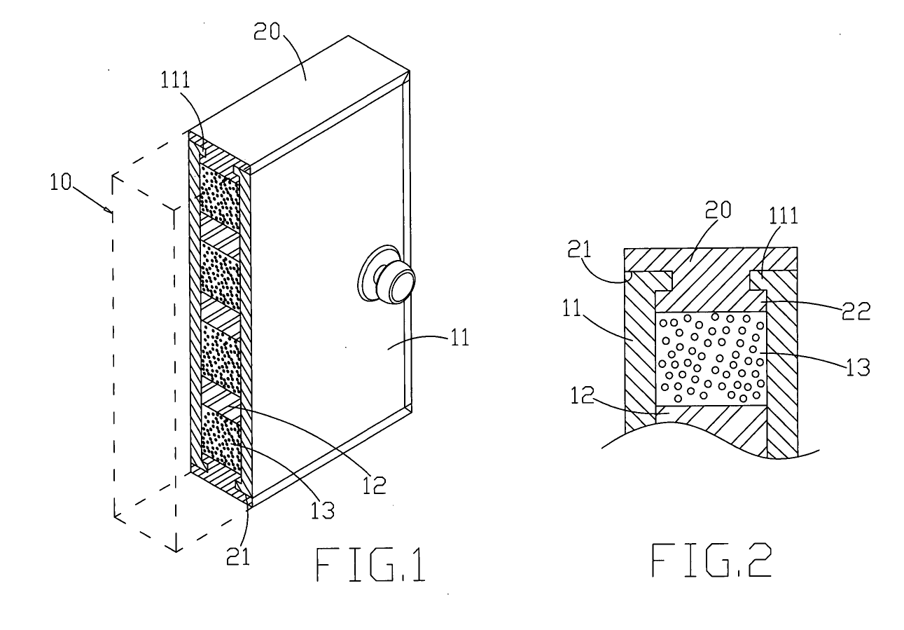

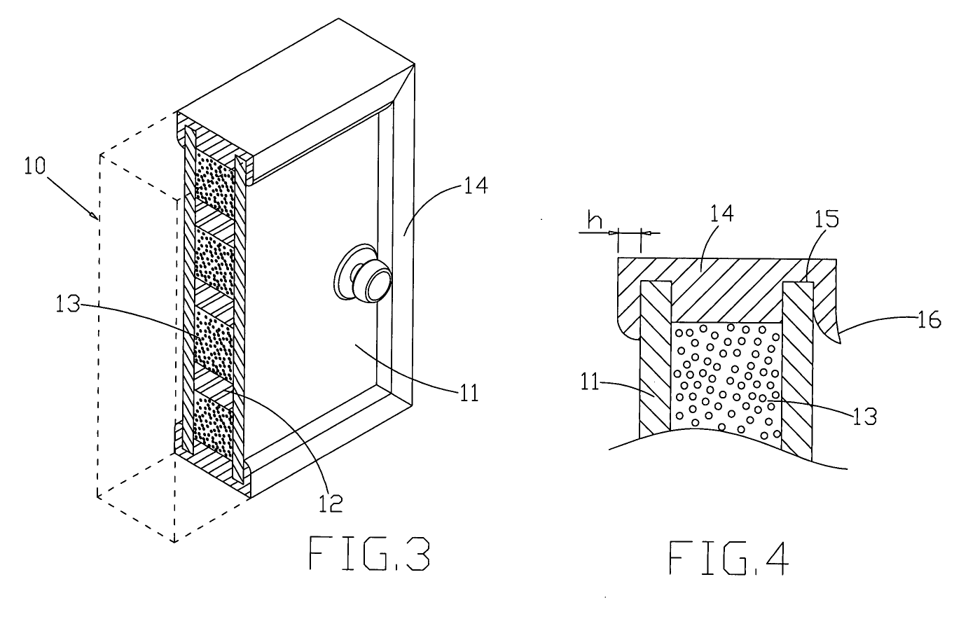

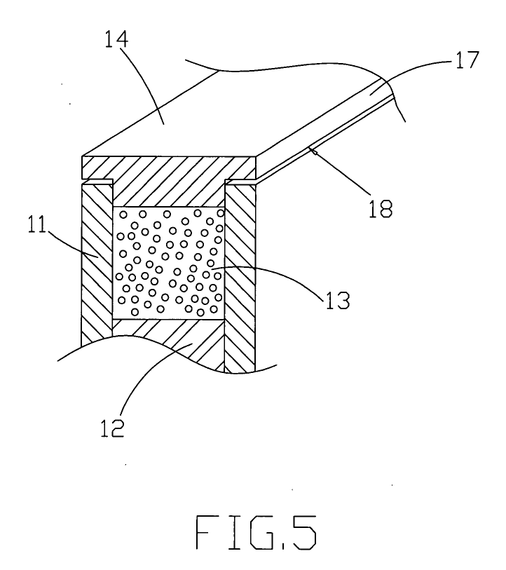

Referring to FIGS. 1 and 2, a door includes two door panels 11 each of which has a pair of projecting stripes 111 at the top and bottom thereof. The four peripheral sides of the door panels 11 are enclosed by sealing strips 20. Each of the sealing strips 20 has an I-shaped section, and includes an attachment portion 22. Two insertion grooves 21 are formed between the sealing strip 20 and the attachment portion 22 to permit the insertion of both door panels 11 with their projecting stripes 111 thereinto. A plurality of stiffening ribs 12 is interposed between both door panels 11. The stiffening ribs 12 are equidistantly spaced apart by regular gaps. Each gap between every two stiffening ribs 12 is filled with fluid foaming agent that produces bubbles when in contact with air. The foaming agent is adhesive so that the attachment portions 22 of the sealing strips 20, the stiffening ribs 12, and the door panels 11 are tightly joined together during the foaming action. Even, the foaming agent can penetrate into the insertion grooves 21 for bringing the door panels 11 and the sealing strips 20 together into a whole. Meanwhile, the fluid foaming agent is converted into a solid foaming material 13. So, the assembly of the door 10 in accordance with the invention is completed. In this way, drawbacks of the prior art can be eliminated by the door 10 of the invention that is completely formed in a rectangular shape without dangerous protrusions or warped portions (sealing rims as described in the precedent prior art). Besides, the door panels 11 are made of fiber-reinforced plastic to create a visual effect of simulation of wood grains. Thus, the sealing rims of the prior art are no more existing in the invention so that the whole appearance won't be affected.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claim.

1. A door of glass fiber-reinforced plastic comprising:
a) a pair of door panels made of glass fiber-reinforced plastic, each of the door panels having a pair of projecting stripes at the top and bottom thereof;
b) four sealing strips each having an I-shaped section, each sealing strip being provided with an attachment portion, a pair of insertion grooves being formed between the sealing strip and the attachment portion to permit the insertion of both door panels with their projecting stripes thereinto; and
c) a plurality of stiffening ribs and foaming materials interposed between both door panels.
